(19) United States
(12) Patent Application Publication
(10) Pub. No.: US 2025/0226751 A1
(43) Pub. Date: Jul. 10, 2025

(54) ELECTRIC POWER SUPPLY CONTROL DEVICE AND SWITCHING ELECTRIC POWER SUPPLY

(71) Applicant: ROHM CO., LTD., Kyoto (JP)

(72) Inventor: Masashi NAGASATO, Kyoto (JP)

(21) Appl. No.: 19/093,226

(22) Filed: Mar. 27, 2025

Related U.S. Application Data
(63) Continuation of application No. PCT/JP2023/028416, filed on Aug. 3, 2023.

(30) Foreign Application Priority Data
Sep. 28, 2022 (JP) 2022-154597

(51) Int. Cl. H02M 3/158; H02M 1/00

(52) U.S. Cl. CPC H02M 3/1588; H02M 1/0025

(57) ABSTRACT

An electric power supply control device includes a control circuit that drives an inductor current by turning on or off an upper-side switch and a lower-side switch of a switching output circuit, so as to generate an output voltage from an input voltage; an error amplifier that compares a feedback voltage corresponding to the output voltage with a predetermined reference voltage so as to output an error signal including voltage feedback information; an information hold unit that samples current feedback information corresponding to an inductor current flowing in the lower-side switch during ON period of the lower-side switch, and holds and outputs the same as a hold signal during ON period of the upper-side switch; and an OFF timing control unit that respectively receives inputs of the error signal and the hold signal, so as to determine OFF timing of the upper-side switch.

### CROSS-REFERENCE TO RELATED APPLICATIONS

This nonprovisional application is a continuation application of International Patent Application No. PCT/JP2023/028416 filed on Aug. 3, 2023, which claims priority Japanese Patent Application No. 2022-154597 filed on Sep. 28, 2022, the entire contents of which are hereby incorporated by reference.

### TECHNICAL FIELD

The present disclosure relates to an electric power supply control device and a switching electric power supply using the same.

### BACKGROUND ART

Conventionally, as electric power supply means in various applications, a switching electric power supply (a so-called DC/DC converter) is used, which generates a desired output voltage from an input voltage.

Note that as an example of a conventional technique related to the above description, Patent Document 1 can be mentioned, which has been applied by this applicant. Patent Document 1 proposes a structure of a current feedback system that detects current flowing through a lower-side switch of a half-bridge, in which voltage feedback information and current feedback information are added and input to a sample hold circuit, so as to synchronize timing and stabilize an output feedback control loop.

### LIST OF CITATIONS

### Patent Literature

Patent Document 1: WO2019/244374

### BRIEF DESCRIPTION OF DRAWINGS

FIG. 1 is a diagram illustrating a comparative example of a switching electric power supply.

FIG. 2 is a diagram illustrating a first embodiment of the switching electric power supply.

FIG. 3 is a diagram illustrating an improvement effect of response characteristics in the first embodiment.

FIG. 4 is a diagram illustrating a second embodiment of the switching electric power supply.

FIG. 5 is a diagram illustrating a third embodiment of the switching electric power supply.

FIG. 6 is a diagram illustrating a fourth embodiment of the switching electric power supply.

### DESCRIPTION OF EMBODIMENTS

### Comparative Example

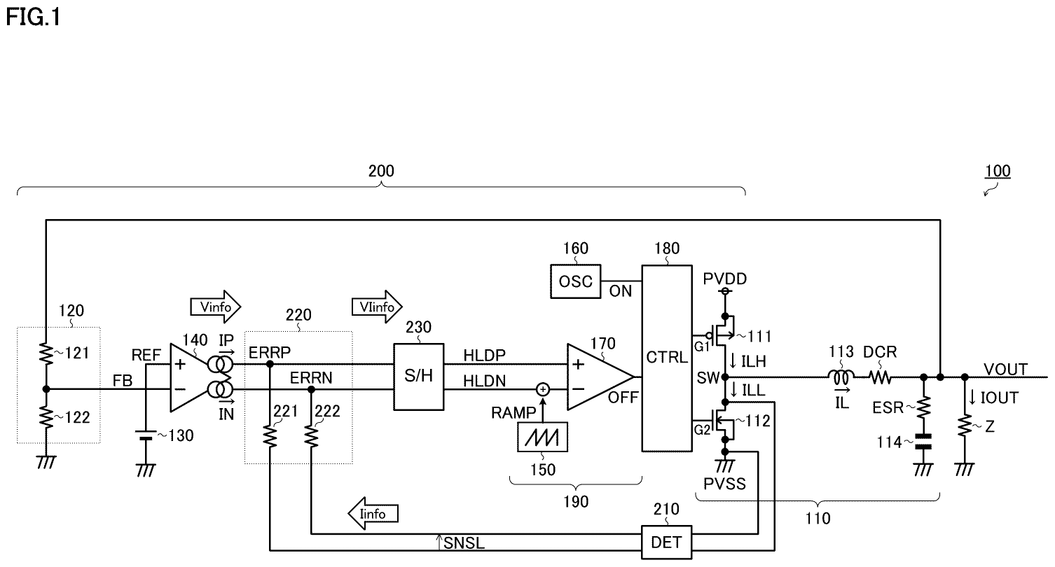

FIG. 1 is a diagram illustrating a comparative example of a switching electric power supply (i.e., a common structure to be compared with an embodiment described later). A switching electric power supply 100 of this comparative example is a pulse width modulation (PWM) drive type DC/DC converter, which generates an output voltage VOUT from an input voltage PVDD and supplies the same to a load Z. Note that the switching electric power supply 100 can be used in various fields. For instance, the switching electric power supply 100 is appropriately used as an in-vehicle secondary power supply.

With reference to this diagram, the switching electric power supply 100 includes a switching output circuit 110, a feedback voltage generation circuit 120, a reference voltage generation circuit 130, an error amplifier 140, a lamp signal generation circuit 150, an oscillator 160, a PWM comparator 170, a control circuit 180, a lower side current detection unit 210, an information combining unit 220, and an information hold unit 230.

It is preferred that the above components be integrated in a semiconductor integrated circuit device 200 (i.e., corresponding to an electric power supply control device) to be a control main body of the switching electric power supply 100, except for some components of the switching output circuit 110 (an inductor 113 and a capacitor 114 in this diagram). Note that any components (such as various protection circuits) other than the above components can be appropriately incorporated in the semiconductor integrated circuit device 200.

The switching output circuit 110 is a step-down type switching output stage, which turns on or off an upper-side switch and a lower-side switch that are connected to each other to form a half-bridge, and thus drives an inductor current IL so as to generate the output voltage VOUT from the input voltage PVDD.

With reference to this diagram, the switching output circuit 110 includes an output transistor 111, a synchronous rectification transistor 112, the inductor 113, and the capacitor 114.

The output transistor 111 is a P-channel type metal oxide semiconductor field effect transistor (PMOSFET) that works as the upper-side switch of the half-bridge. The source of the output transistor 111 is connected to an application terminal of the input voltage PVDD. The drain of the output transistor 111 is connected to an application terminal of a switch voltage SW. The gate of the output transistor 111 is connected to an application terminal of an upper-side gate signal G1. The output transistor 111 is in OFF state when the upper-side gate signal G1 has high level, while it is in ON state when the upper-side gate signal G1 has low level.

The synchronous rectification transistor 112 is an N-channel type MOSFET (NMOSFET) that works as the lower-side switch of the half-bridge. The source of the synchronous rectification transistor 112 is connected to an application terminal of a ground voltage PVSS (i.e., a ground terminal). The drain of the synchronous rectification transistor 112 is connected to an application terminal of the switch voltage SW. The gate of the synchronous rectification transistor 112 is connected to an application terminal of a lower-side gate signal G2. The synchronous rectification transistor 112 is in ON state when the lower-side gate signal G2 has high level, while it is in OFF state when the lower-side gate signal G2 has low level.

The inductor 113 and the capacitor 114 are discrete components that are externally connected to the semiconductor integrated circuit device 200, and form an LC filter for rectifying and smoothing the switch voltage SW so as to generate the output voltage VOUT. A first end of the inductor 113 is connected to an application terminal of the switch voltage SW. A second end of the inductor 113 and a first end of the capacitor 114 are connected to an application terminal of the output voltage VOUT and the feedback voltage generation circuit 120. A second end of the capacitor 114 is connected to the ground terminal. Note that the inductor 113 and the capacitor 114 are accompanied with a resistance component DCR and a resistance component ESR, respectively.

The output transistor 111 and the synchronous rectification transistor 112 are complementarily turned on or off in accordance with the upper-side gate signal G1 and the lower-side gate signal G2. This turning on and off operation generates the switch voltage SW having a rectangular wave shape, which is pulse-driven between the input voltage PVDD and a ground voltage GND, at the first end of the inductor 113. The above language “complementarily” includes not only a case where ON/OFF states of the output transistor 111 and the synchronous rectification transistor 112 are completely opposite, but also a case where there is a simultaneous OFF period of both the transistors (a dead time).

Note that the output type of the switching output circuit 110 is not limited to the above step-down type, but may be any one of a step-up type, a step-up/down type, and an inversion type. In addition, the rectification type of the switching output circuit 110 is also not limited to the above synchronous rectification type, and it may be possible to adopt a diode rectification type that uses a rectifying diode as the lower-side switch.

In addition, it may also be possible to replace the output transistor 111 with an NMOSFET. However, in that case, in order to increase high level of the upper-side gate signal G1 to a voltage value higher than the input voltage PVDD, a bootstrap circuit or a charge pump circuit is necessary.

In addition, the output transistor 111 and the synchronous rectification transistor 112 may be externally connected to the semiconductor integrated circuit device 200.

In particular, if a high voltage is applied to the switching output circuit 110, a high withstand voltage element such as a power MOSFET, an insulated gate bipolar transistor (IGBT), or a SiC transistor should be used as each of the output transistor 111 and the synchronous rectification transistor 112. In addition, a GaN device may be used as each of the output transistor 111 and the synchronous rectification transistor 112.

The feedback voltage generation circuit 120 includes resistors 121 and 122 connected in series between the application terminal of the output voltage VOUT and the ground terminal. The feedback voltage generation circuit 120 outputs a feedback voltage FB corresponding to the output voltage VOUT (i.e., a divided voltage of the output voltage VOUT) from a connection node between the resistors 121 and 122.

Note that if the output voltage VOUT is within an input dynamic range of the error amplifier 140, the feedback voltage generation circuit 120 may be eliminated, and the output voltage VOUT may be directly input to the error amplifier 140.

In addition, the resistors 121 and 122 may be externally connected to the semiconductor integrated circuit device 200.

The reference voltage generation circuit 130 generates a predetermined reference voltage REF (i.e., corresponding to a target set value of the output voltage VOUT). Note that as the reference voltage generation circuit 130, it is preferred to use a digital-to-analog converter (DAC), which converts a digital reference voltage set signal to the analog reference voltage REF. With this structure, it is possible to realize an initial soft-start operation and to adjust the output voltage VOUT, using the above reference voltage set signal.

The error amplifier 140 generates an error signal ERR (=ERRP−ERRN) including voltage feedback information Vinfo, in accordance with the difference between the feedback voltage FB applied to an inverting input terminal (−) and the reference voltage REF applied to a noninverting input terminal (+). The error signal ERR increases when the feedback voltage FB is lower than the reference voltage REF, while it decreases when the feedback voltage FB is higher than the reference voltage REF.

Note that in this diagram, as the error amplifier 140, a current output type amplifier is used, which outputs differential current signals IP and IN. The differential current signals IP and IN are currents that flow in opposite directions to each other, and increase or decrease in accordance with the difference between the feedback voltage FB and the reference voltage REF.

More specifically, when REF>FB holds, the larger the difference between them, the differential current signal IP is larger in a positive direction (i.e., the direction flowing out from the error amplifier 140), while when REF<FB holds, the larger the difference between them, the differential current signal IP is larger in a negative direction (i.e., the direction flowing into the error amplifier 140).

In contrast, opposite to the differential current signal IP, when REF>FB holds, the larger the difference between them, the differential current signal IN is larger in the negative direction, while when REF<FB holds, the larger the difference between them, the differential current signal IN is larger in the positive direction.

The lower side current detection unit 210 detects the inductor current IL that flows during ON period of the synchronous rectification transistor 112 (hereinafter referred to as a lower-side inductor current ILL), so as to obtain current feedback information Iinfo.

For instance, during ON period of the synchronous rectification transistor 112, as the above current feedback information Iinfo, a lower-side sense signal SNSL (=SW−PVSS=−ILL×RonL, where RonL is ON resistance of the synchronous rectification transistor 112) corresponding to the lower-side inductor current ILL is transferred to the information combining unit 220. On the other hand, during OFF period of the synchronous rectification transistor 112, the lower-side sense signal SNSL is fixed to zero value. Therefore, high level (≈PVDD) of the switch voltage SW is not transferred to the information combining unit 220.

Note that as a method for detecting the lower-side inductor current ILL, other than a method of detecting a drain-source voltage of the synchronous rectification transistor 112, any method can be adopted. For instance, it may be possible to detect a voltage across a sense resistor that is connected in series to the synchronous rectification transistor 112.

Alternatively, it may be possible to detect a drain-source voltage of a current detecting transistor that is connected in parallel to the synchronous rectification transistor 112.

The information combining unit 220 combines the voltage feedback information Vinfo obtained by the error amplifier 140 and the current feedback information Iinfo obtained by the lower side current detection unit 210, so as to generate combined feedback information VIinfo. With reference to this diagram, the information combining unit 220 includes resistors 221 and 222 (both having a resistance value R).

A first end of the resistor 221 is connected to a first output terminal of the error amplifier 140 (i.e., an output terminal of the differential current signal IP). A second end of the resistor 221 is connected to a first output terminal of the lower side current detection unit 210 (i.e., an output terminal of the lower-side sense signal SNSL).

A first end of the resistor 222 is connected to a second output terminal of the error amplifier 140 (i.e., an output terminal of the differential current signal IN). A second end of the resistor 222 is connected to a second output terminal of the lower side current detection unit 210 (i.e., an application terminal of the ground voltage PVSS).

Note that a positive differential error signal (voltage signal) output from the first end of the resistor 221 can be expressed by ERRP=IPxR+SW. In addition, a negative differential error signal (voltage signal) output from the first end of the resistor 222 can be expressed by ERRN=IN×R+PVSS (where IN=−IP).

Therefore, a difference signal between the differential error signals ERRP and ERRN is expressed by ERRP−ERRN=2IP×R−ILL×RonL. Here, the first term in the right side (2IP×R) can be understood to be the voltage feedback information Vinfo obtained by the error amplifier 140. In addition, the second term in the right side (−ILL×RonL) can be understood to be the current feedback information Iinfo obtained by the lower side current detection unit 210. Therefore, the above difference signal (ERRP−ERRN) can be understood to be the combined feedback information VIinfo obtained by combining the current feedback information Iinfo to the voltage feedback information Vinfo.

The information hold unit 230 samples the combined feedback information VIinfo during ON period of the synchronous rectification transistor 112, and holds and outputs the same as differential hold signals HLDP and HLDN during ON period of the output transistor 111. Note that the combined feedback information VIinfo includes the current feedback information Iinfo (e.g., information about a lower-side peak value of the inductor current IL).

With reference to this diagram, the information hold unit 230 samples each of the differential error signals ERRP and ERRN during ON period of the synchronous rectification transistor 112, while it holds and outputs each of the differential hold signals HLDP and HLDN during ON period of the output transistor 111.

The lamp signal generation circuit 150 generates a lamp signal RAMP having a triangular wave shape, a sawtooth waveform shape, or a n-th slope wave shape (e.g., n=2), which increases during ON period Ton of the output transistor 111. Note that the lamp signal RAMP starts to increase from zero value at ON timing of the output transistor 111, and is reset to zero value at OFF timing of the output transistor 111, for example.

The oscillator 160 generates an ON signal ON (i.e., a clock signal), which is pulse-driven at a predetermined switching frequency fsw (=1/Tsw).

The PWM comparator 170 compares the lamp signal RAMP (more precisely, the differential hold signal HLDN to which the lamp signal RAMP is added) input to the inverting input terminal (−), with the differential hold signal HLDP input to the noninverting input terminal (+), so as to generate an OFF signal OFF, during ON period of the output transistor 111. By this comparing process, OFF timing of the output transistor 111 is determined.

The above OFF signal OFF has high level when the lamp signal RAMP is lower than the error signal ERR (=ERRP−ERRN), while it has low level when the lamp signal RAMP is higher than the error signal ERR. In other words, the pulse generation timing of the OFF signal OFF is later as the error signal ERR is higher, while it is earlier as the error signal ERR is lower.

The control circuit 180 generates the upper-side gate signal G1 and the lower-side gate signal G2 in accordance with the ON signal ON and the OFF signal OFF. Specifically, when a pulse is generated on the ON signal ON, the control circuit 180 drops each of the upper-side gate signal G1 and the lower-side gate signal G2 to low level (i.e., a logic level when the switch voltage SW has high level). On the other hand, when a pulse is generated on the OFF signal OFF, the control circuit 180 raises each of the upper-side gate signal G1 and the lower-side gate signal G2 to high level (i.e., a logic level when the switch voltage SW has low level).

Therefore, ON period Ton of the output transistor 111 (i.e., a high level period of the switch voltage SW) is longer as the pulse generation timing of the OFF signal OFF is later, while it is shorter as the pulse generation timing of the OFF signal OFF is earlier. In other words, a duty factor D (=Ton/Tsw) of the output transistor 111 is larger as the error signal ERR (=ERRP−ERRN) is higher, while it is smaller as the error signal ERR is lower.

With the switching electric power supply 100 of this embodiment, it is possible to realize an output feedback control of a current mode control type. Therefore, it is possible to enhance response characteristics of the output voltage VOUT, compared with an output feedback control of a voltage mode control type.

In particular, the switching electric power supply 100 of this comparative example adopts a structure for detecting not the inductor current IL flowing in the output transistor 111 (hereinafter, referred to as an upper-side inductor current ILH), but the lower-side inductor current ILL flowing in the synchronous rectification transistor 112. With this structure, even if ON period of the output transistor 111 becomes short (e.g., when a high voltage is input or when a low voltage is output), the output feedback control of the current mode control type can be performed without any trouble.

Note that in order to perform the output feedback control of the current mode control type using the current feedback information Iinfo corresponding to the lower-side inductor current ILL, the information hold unit 230 is essential for holding the current feedback information Iinfo, which is obtained during ON period of the synchronous rectification transistor 112 (i.e., OFF period of the output transistor 111).

Here, the information hold unit 230 is disposed between the information combining unit 220 and the PWM comparator 170, and holds the combined feedback information VIinfo obtained by combining the current feedback information Iinfo with the voltage feedback information Vinfo.

With this structure, during a hold output period of the information hold unit 230, even if noise is superimposed in a pre-stage of the information hold unit 230, the signal comparing process in the PWM comparator 170 is not affected. Therefore, stable duty control can be realized.

In addition, by performing sample-hold processing after addition of the voltage feedback information Vinfo and the current feedback information Iinfo, it is possible to prevent temporal inconsistency between the voltage feedback information Vinfo and the current feedback information Iinfo, and to improve performance of the switching electric power supply 100.

However, the switching electric power supply 100 of this comparative example may cause a response delay due to the sample-hold processing not only in a current feedback control loop but also in a voltage feedback control loop. For this reason, there is room for further improvement in enhancing the response characteristics.

In view of the above considerations, a novel embodiment is proposed as follows, which can pursue limitation of the response characteristics.

### First Embodiment

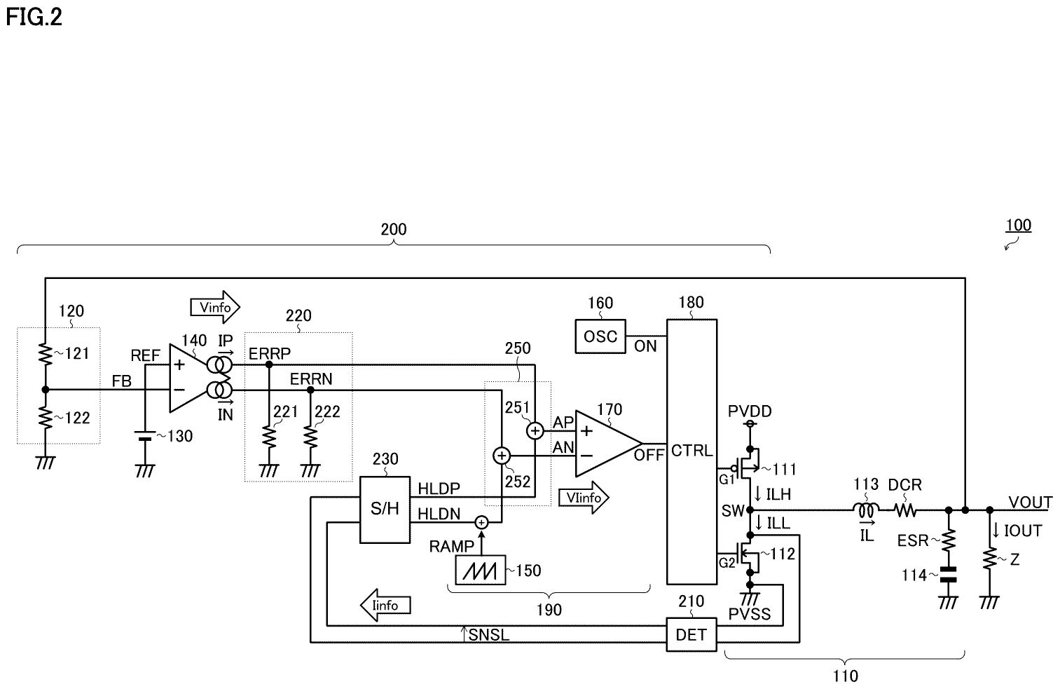

FIG. 2 is a diagram illustrating a first embodiment of the switching electric power supply. The switching electric power supply 100 of this embodiment is based on the comparative example (FIG. 1) described above, and further includes an addition unit 250, in which combining path of the voltage feedback information Vinfo and the current feedback information Iinfo is changed. Hereinafter, the changed point is mainly described.

The lower-side sense signal SNSL including the current feedback information Iinfo is not input to the information combining unit 220 (i.e., the second end of each of the resistors 221 and 222), but is directly input to the information hold unit 230. The second end of each of the resistors 221 and 222 is connected to the ground terminal. In this way, the information combining unit 220 is no longer a functional unit that combines the voltage feedback information Vinfo and the current feedback information Iinfo, but can be understood as a functional unit (a phase compensation resistor unit) that generates the differential error signals ERRP and ERRN simply in accordance with the differential current signals IP and IN.

The information hold unit 230 samples the current feedback information Iinfo (e.g., information about the lower-side peak value of the inductor current IL) during ON period of the synchronous rectification transistor 112, and holds and outputs the same as the differential hold signals HLDP and HLDN including the current feedback information Iinfo during ON period of the output transistor 111.

The addition unit 250 adds the differential error signals ERRP and ERRN with the differential hold signals HLDP and HLDN, so as to output differential addition signals AP and AN including the combined feedback information VIinfo. With reference to this diagram, the addition unit 250 includes adders 251 and 252.

The adder 251 adds the differential error signal ERRP and the differential hold signal HLDP so as to output the differential addition signal AP. The adder 252 adds the differential error signal ERRN and the differential hold signal HLDN on which the lamp signal RAMP is superimposed, so as to output the differential addition signal AN.

The PWM comparator 170 compares the differential addition signal AN input to the inverting input terminal (−) with the differential addition signal AP input to the noninverting input terminal (+), so as to generate the OFF signal OFF, during ON period of the output transistor 111. In other words, in the PWM comparator 170, the lamp signal RAMP is compared with an addition signal ADD (=AP−AN), and hence OFF timing of the output transistor 111 is determined.

Note that among the above components, the lamp signal generation circuit 150, the PWM comparator 170, and the addition unit 250 can be understood to be an OFF timing control unit 190, which respectively receives inputs of the differential error signals ERRP and ERRN, and the differential hold signals HLDP and HLDN, so as to determine OFF timing of the output transistor 111.

With the switching electric power supply 100 of this embodiment, the voltage feedback information Vinfo is directly input to the PWM comparator 170 without going through the information hold unit 230. Therefore, by gain adjustment of the error amplifier 140, the voltage feedback control loop can be adjusted freely. As a result, the response delay in the information hold unit 230 due to the sample-hold processing can be resolved.

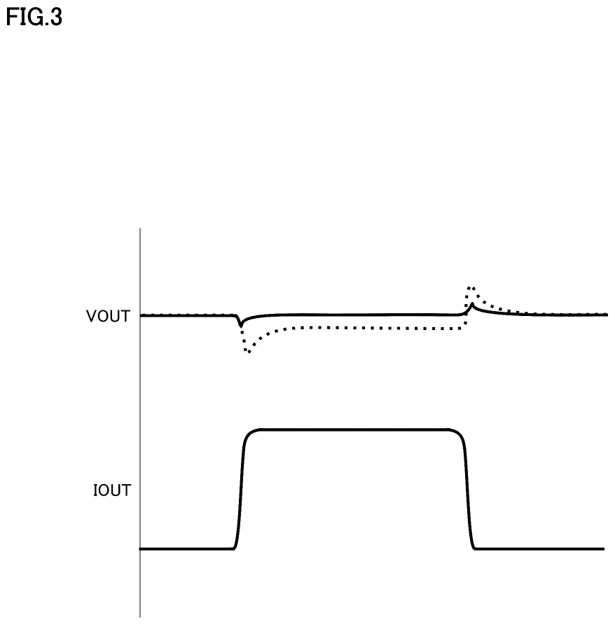

FIG. 3 is a diagram illustrating an improvement effect of response characteristics in the first embodiment (in this diagram, load response characteristics). In this diagram, the output voltage VOUT supplied to the load Z and the output current IOUT are shown in order from top to bottom. In addition, for the output voltage VOUT, a solid line indicates a behavior in the first embodiment (FIG. 2), and a broken line indicates a behavior in the comparative example (FIG. 1).

As illustrated in this diagram, with the switching electric power supply 100 of this embodiment, the response characteristics can be improved much more than the comparative example (FIG. 1). Note that an oscillation margin can be adjusted to a level having no problem, though stability is sacrificed a little.

### Second Embodiment

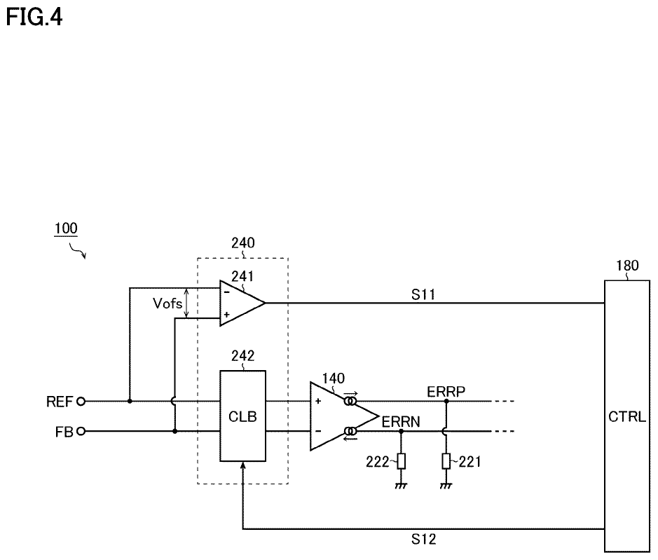

FIG. 4 is a diagram illustrating a second embodiment of the switching electric power supply 100. The switching electric power supply 100 of this embodiment is based on the first embodiment (FIG. 2) described above, and further includes an error correction unit 240, which detects an input error Vofs (=FB−REF) of the error amplifier 140 that does not have an integral element, so as to correct an input signal of the error amplifier 140 (i.e., at least one of the feedback voltage FB and the reference voltage REF). Note that the error correction unit 240 includes a comparator 241 and a digital calibration unit 242.

The comparator 241 is means for detecting the input error Vofs (=FB−REF) of the error amplifier 140, and compares the feedback voltage FB input to the noninverting input terminal (+) with the reference voltage REF input to the inverting input terminal (−), so as to generate an input error detection signal S11. Note that the input error detection signal S11 has high level when FB>REF (i.e., Vofs>0) holds, while it has low level when FB<REF (i.e., Vofs<0) holds.

The control circuit 180 generates a digital calibration signal S12 so that the input error Vofs is decreased on the basis of the input error detection signal S11. For instance, when the input error detection signal S11 has high level, the digital calibration signal S12 should be generated so as to decrease the feedback voltage FB, or to increase the reference voltage REF, or to perform both of them. On the contrary, if the input error detection signal S11 has low level, the digital calibration signal S12 should be generated so as to increase the feedback voltage FB, or to decrease the reference voltage REF, or to perform both of them.

The digital calibration unit 242 corrects at least one of the feedback voltage FB and the reference voltage REF, in accordance with the digital calibration signal S12. Note that as the digital calibration unit 242, a DAC or the like is appropriately used. In addition, it may be possible to configure so that the input error detection signal S11 is directly input to the digital calibration unit 242, and that the digital calibration signal S12 is generated inside the same. In this case, the control circuit 180 is not necessary, and the correction process of the input error Vofs can be completed only by the error correction unit 240.

Next, meaning of introducing the error correction unit 240 is described in detail.

A usual error amplifier has a phase compensating capacitor (e.g., a few tens pF) to be the integral element, and performs charge and discharge of the same so as to generate an error signal. For this reason, oscillation can hardly occur while the signal band is restricted, and hence it is not suitable for increasing speed of the voltage feedback control loop. On the other hand, if the integral element is eliminated from the error amplifier, higher speed of the voltage feedback control loop can be realized, but instead the input error of the error amplifier can hardly be canceled.

Therefore, in the switching electric power supply 100 of this embodiment, the error amplifier 140 that does not have an integral element is used for increasing speed of the voltage feedback control loop (up to a few tens kHz to a few MHz), while besides the error amplifier 140, the error correction unit 240 is introduced for correcting the input error Vofs of the error amplifier 140.

In this way, increasing speed of the voltage feedback and error correction are parallelized so that design parameters thereof can be separated from each other, and hence increasing speed of the voltage feedback control loop and increasing accuracy can both be achieved. In addition, unlike a usual error amplifier, the phase compensating capacitor is not necessary, and hence it is also possible to reduce the chip area and the number of pins.

### Third Embodiment

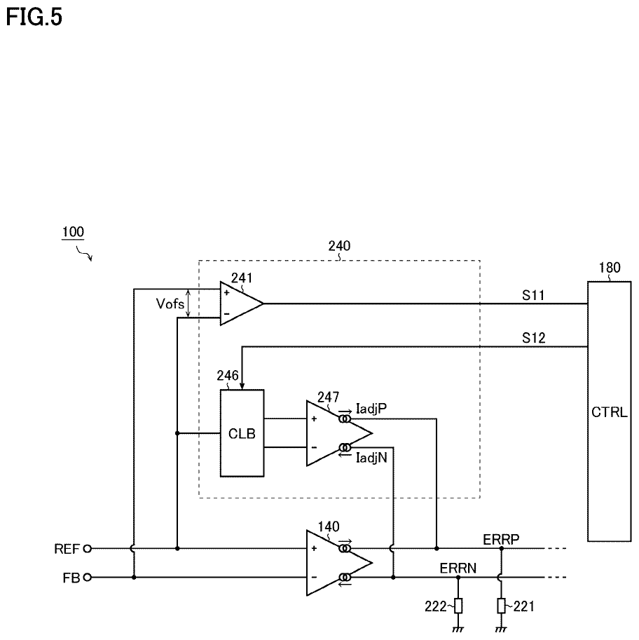

FIG. 5 is a diagram illustrating a third embodiment of the switching electric power supply 100. The switching electric power supply 100 of this embodiment includes the error correction unit 240 similarly to the second embodiment (FIG. 4) described above, but the circuit structure thereof is different.

More specifically, the error correction unit 240 of this embodiment includes, together with the comparator 241 described above, a digital calibration unit 246 and an error correction amplifier 247, and it detects the input error Vofs of the error amplifier 140 so as to correct the output signal of the error amplifier 140 (i.e., the differential error signals ERRP and ERRN).

The digital calibration unit 246 generates differential input signals to the error correction amplifier 247 from the reference voltage REF, in accordance with the digital calibration signal S12.

The error correction amplifier 247 generates correction currents IadjP and IadjN corresponding to the differential input signals from the digital calibration unit 246, and adds them to the differential current signals IP and IN of the error amplifier 140.

In this way, it is possible to achieve both increasing speed of the voltage feedback control loop and increasing accuracy, not by correcting the input signal of the error amplifier 140, but by correcting the output signal of the error amplifier 140.

### Fourth Embodiment

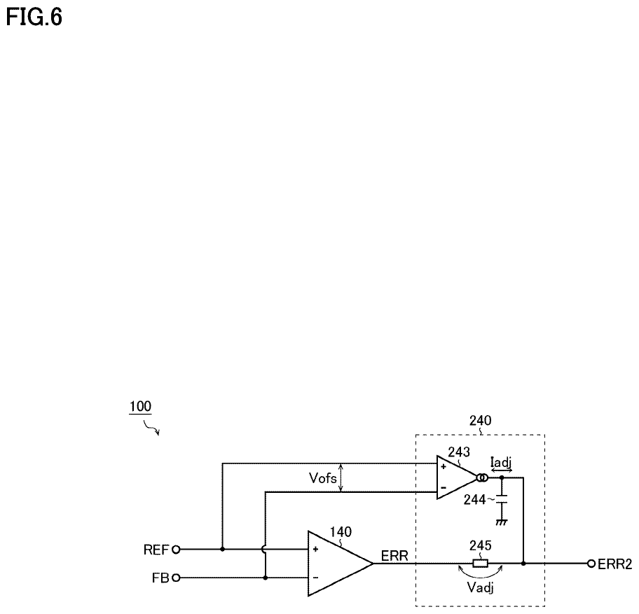

FIG. 6 is a diagram illustrating a fourth embodiment of the switching electric power supply 100. The switching electric power supply 100 of this embodiment includes the error correction unit 240 similarly to the second embodiment (FIG. 4) or the third embodiment (FIG. 5) described above, but the circuit structure thereof is different.

More specifically, the error correction unit 240 of this embodiment includes an error correction amplifier 243, a capacitor 244, and a resistor 245, and it detects the input error Vofs of the error amplifier 140 so as to correct the output signal of the error amplifier 140 (i.e., the error signal ERR).

Note that, for simple description, the error amplifier 140 is a single output type in this embodiment, but the error amplifier 140 may be a differential output type similarly to the first embodiment (FIG. 2), the second embodiment (FIG. 4), or the third embodiment (FIG. 5) described above.

The error correction amplifier 243 generates a correction current Iadj, which corresponds to the difference (i.e., the input error Vofs) between the feedback voltage FB applied to the inverting input terminal (−) and the reference voltage REF applied to the noninverting input terminal (+). Note that when FB<REF (i.e., Vofs>0) holds, the larger the difference between them, the correction current Iadj is larger in the positive direction (i.e., the direction from an output terminal of the error correction amplifier 243 to the output terminal of the error amplifier 140 via the resistor 245). On the contrary, when FB>REF (i.e., Vofs<0) holds, the larger the difference between them, the correction current Iadj is larger in the negative direction (i.e., the direction from the output terminal of the error amplifier 140 to the output terminal of the error correction amplifier 243 via the resistor 245).

However, the error correction amplifier 243 is connected in parallel to the error amplifier 140 just as means for correcting the input error Vofs, and current capability of the error correction amplifier 243 is controlled to be sufficiently smaller than that of the error amplifier 140 (e.g., to be a few μA). In addition, the capacitor 244 having a small capacitance (e.g., a few pF) is connected to the output terminal of the error correction amplifier 243. In other words, the error correction amplifier 243 can be said to be a current output type amplifier that has an integral element and has a lower speed than the error amplifier 140.

The resistor 245 (having a resistance Radj) is connected between the output terminal of the error amplifier 140 and the output terminal of the error correction amplifier 243, and adds the voltage across the same as a correction voltage Vadj (=Iadj×Radj) to the error signal ERR, so as to generate a corrected error signal ERR2 (=ERR+Vadj).

For instance, when FB<REF holds, the correction current Iadj flows in the positive direction, and hence the error signal ERR is increased by the correction voltage Vadj. As a result, OFF timing of the output transistor 111 is delayed corresponding to the increase in the corrected error signal ERR2, and hence the output voltage VOUT (then, the feedback voltage FB) is increased, and the input error Vofs is decreased.

On the other hand, when FB>REF holds, the correction current Iadj flows in the negative direction, and hence the error signal ERR is decreased by the correction voltage Vadj. As a result, OFF timing of the output transistor 111 is advanced corresponding to the decrease in the corrected error signal ERR2, and hence the output voltage VOUT (then, the feedback voltage FB) is decreased, and the input error Vofs is decreased.

In this way, by connecting the error correction amplifier 243 in parallel to the error amplifier 140, increasing speed of the voltage feedback control loop and increasing accuracy can both be achieved, similarly to the second embodiment (FIG. 4) or the third embodiment (FIG. 5) described above.

### Generalization

According to the present disclosure, it is possible to provide an electric power supply control device that can improve the response characteristics of a current feedback system that detects a current flowing through a lower-side switch of a half-bridge, and a switching power supply that uses the same. Hereinafter, the above various embodiments are described in a generalized manner.

For instance, the electric power supply control device disclosed in this specification has a structure (first structure) including a control circuit configured to drive an inductor current by turning on or off an upper-side switch and a lower-side switch of a switching output circuit, so as to generate an output voltage from an input voltage; an error amplifier configured to compare the output voltage or a feedback voltage corresponding thereto with a predetermined reference voltage, so as to output an error signal including voltage feedback information; an information hold unit configured to sample current feedback information corresponding to the inductor current flowing in the lower-side switch during ON period of the lower-side switch, and configured to hold and output the same as a hold signal including the current feedback information during ON period of the upper-side switch; and an OFF timing control unit configured to respectively receive inputs of the error signal and the hold signal, so as to determine OFF timing of the upper-side switch.

Note that the electric power supply control device having the above first structure may have a structure (second structure), in which the OFF timing control unit includes an addition unit configured to add the error signal and the hold signal so as to output an addition signal including combined feedback information, a lamp signal generation circuit configured to generate a lamp signal, and a PWM comparator configured to compare the lamp signal with the addition signal during ON period of the upper-side switch, so as to determine OFF timing of the upper-side switch.

In addition, the electric power supply control device having the above first or second structure may have a structure (third structure), further including an error correction unit configured to detect an input error of the error amplifier that does not have an integral element, so as to correct an input signal or an output signal of the error amplifier.

In addition, the electric power supply control device having the above third structure may have a structure (fourth structure), wherein the error correction unit includes a comparator configured to detect an input error of the error amplifier, and a digital calibration unit configured to correct an input signal or an output signal of the error amplifier in accordance with a detection result of the comparator.

In addition, the electric power supply control device having the above third structure may have a structure (fifth structure), in which the error correction unit includes an error correction amplifier having a lower speed than the error amplifier, in parallel to the error amplifier.

In addition, the electric power supply control device having any one of the above first to fifth structures may have a structure (sixth structure), in which the device is integrated into a semiconductor integrated circuit device.

In addition, for example, the switching electric power supply disclosed in this specification has a structure (seventh structure), including the switching output circuit and the electric power supply control device having any one of the above first to sixth structure.

### Other Variations

Note that the various technical features disclosed in this specification can be, besides the above embodiment, variously modified within the scope without deviating from the spirit of the technical creation. In other words, the embodiment described above is merely an example in every aspect and should not be interpreted as a limitation. In addition, the technical scope of the present disclosure is defined by the claims, and should be understood to include all modifications within meaning and scope equivalent to the claims.

1. An electric power supply control device comprising:
a control circuit configured to drive an inductor current by turning on or off an upper-side switch and a lower-side switch of a switching output circuit, so as to generate an output voltage from an input voltage;
an error amplifier configured to compare the output voltage or a feedback voltage corresponding thereto with a predetermined reference voltage, so as to output an error signal including voltage feedback information;
an information hold unit configured to sample current feedback information corresponding to the inductor current flowing in the lower-side switch during ON period of the lower-side switch, and configured to hold and output the same as a hold signal including the current feedback information during ON period of the upper-side switch; and
an OFF timing control unit configured to respectively receive inputs of the error signal and the hold signal, so as to determine OFF timing of the upper-side switch.

2. The electric power supply control device according to claim 1, wherein the OFF timing control unit includes:
an addition unit configured to add the error signal and the hold signal so as to output an addition signal including combined feedback information;
a lamp signal generation circuit configured to generate a lamp signal; and
a PWM comparator configured to compare the lamp signal with the addition signal during ON period of the upper-side switch, so as to determine OFF timing of the upper-side switch.

3. The electric power supply control device according to claim 1, further comprising an error correction unit configured to detect an input error of the error amplifier that does not have an integral element, so as to correct an input signal or an output signal of the error amplifier.

4. The electric power supply control device according to claim 3, wherein the error correction unit includes:
a comparator configured to detect an input error of the error amplifier; and
a digital calibration unit configured to correct an input signal or an output signal of the error amplifier in accordance with a detection result of the comparator.

5. The electric power supply control device according to claim 3, wherein the error correction unit includes an error correction amplifier having a lower speed than the error amplifier, in parallel to the error amplifier.

6. The electric power supply control device according to claim 1, wherein the device is integrated into a semiconductor integrated circuit device.

7. A switching electric power supply comprising:
the switching output circuit; and
the electric power supply control device according to claim 1.
